(19) United States
(12) Patent Application Publication
(10) Pub. No.: US 2018/0226719 A1
(43) Pub. Date: Aug. 9, 2018

(54) ANTENNA APERTURE TUNING AND RELATED METHODS

(71) Applicant: BlackBerry Limited, Waterloo (CA)

(72) Inventor: Joshua WONG, Waterloo (CA)

(73) Assignee: BlackBerry Limited, Waterloo (CA)

(21) Appl. No.: 15/948,033

(22) Filed: Apr. 9, 2018

Related U.S. Application Data
(62) Division of application No. 15/136,424, filed on Apr. 22, 2016.

(51) Int. Cl. H01Q 9/04; H01Q 1/24; H01Q 1/48; H01Q 21/00; H01Q 5/378; H01Q 1/52; H01Q 5/321

(52) U.S. Cl. CPC H01Q 9/0442; H01Q 1/243; H01Q 9/045; H01Q 1/48; H01Q 21/28; H01Q 5/378; H01Q 1/521; H01Q 5/321; H01Q 21/00

(57) ABSTRACT

An antenna assembly includes an antenna feed, and a first radiating element connecting to the antenna feed, where the first radiating element includes a proximal radiating segment and a distal radiating segment. The antenna assembly also includes a tunable circuit coupling the proximal radiating segment and the distal radiating segment. The tunable circuit is configured to adjust a resonant frequency of the antenna assembly to a predetermined frequency.

### TECHNICAL FIELD

This disclosure relates to frequency tunable antennas in wireless communication systems and, more specifically, to antenna aperture tuning and related methods.

### BACKGROUND

Current mobile wireless communications devices, such as smartphones, tablets and the like, may need to operate at a variety of frequency bands to support roaming or multiple radio access technologies, for example, operating at Long Term Evolution (LTE) bands, Global System for Mobile Communications (GSM) bands, Universal Mobile Telecommunications System (UMTS) bands, and/or wireless local area network (WLAN) bands, covering frequency ranges such as 700-960 MHz, 1710-2170 MHz, and 2500-2700 MHz. In some cases, a device may need to support carrier aggregation so that the device can aggregate multiple frequency carriers to increase data transmission rates. Frequency tunable antennas can be used in mobile devices to support operations at different frequencies.

### DESCRIPTION OF DRAWINGS

FIG. 1 shows an example mobile wireless communications device, according to some implementations.

FIG. 2A illustrates aperture tuning for a planar inverted “F” antenna (PIFA), according to some implementations.

FIG. 2B illustrates aperture tuning for an inverted “L” antenna, according to some implementations.

FIG. 2C illustrates aperture tuning for a parasitic monopole antenna, according to some implementations.

FIG. 3A illustrates a frequency tunable PIFA using impedance tuning, according to some implementations.

FIG. 3B illustrates a first example of impedance tuning for a PIFA, according to some implementations.

FIG. 3C illustrates a second example of impedance tuning for a PIFA, according to some implementations.

FIG. 3D illustrates a third example of impedance tuning for a PIFA, according to some implementations.

FIG. 4A illustrates using impedance tuning to enable frequency tuning for a parasitic monopole antenna, according to some implementations.

FIG. 4B illustrates a first example of impedance tuning for a parasitic monopole antenna, according to some implementations.

FIG. 4C illustrates a second example of impedance tuning for a parasitic monopole antenna, according to some implementations.

FIG. 4D illustrates a third example of impedance tuning for a parasitic monopole antenna, according to some implementations.

FIG. 5 illustrates an example top patch of a PIFA, according to some implementations.

FIG. 6 illustrates a MIMO antenna assembly, according to some implementations.

FIG. 7 illustrates example components of a mobile wireless communications device that may be used in accordance with the described antenna assemblies.

FIG. 8 is a flowchart illustrating an example method for aperture tuning, according to some implementations.

Like reference numbers and designations in the various drawings indicate like elements.

### DETAILED DESCRIPTION

The present disclosure is directed to antenna aperture tuning and related methods. In particular, frequency tunable antennas are implemented using tunable circuits in antenna assemblies. For example, aperture tuning may adjust an antenna resonant frequency by changing an electrical length of a radiating element of the antenna. In some implementations, impedance tuning may adjust an antenna resonant frequency by changing a loading impedance between a radiating element of the antenna and a ground. In some cases, two antennas of a multiple-input multiple-output (MIMO) system can be coupled by a tunable circuit to reduce a correlation between radiating patterns of the two antennas and hence optimize a MIMO system performance.

In some implementations, an antenna assembly can include an antenna feed, and a first radiating element connecting to the antenna feed, where the first radiating element includes a proximal radiating segment and a distal radiating segment. The antenna assembly can also include a tunable circuit coupling the proximal radiating segment and the distal radiating segment. The tunable circuit is configured to adjust a resonant frequency of the antenna assembly to a predetermined frequency. The tunable circuit can include a tunable capacitor, where the tunable capacitor can have a substantially continuous range of capacitance. The tunable circuit can be adjusted to modify an electrical length of the first radiating element, and modifying the electrical length changes the resonant frequency of the antenna assembly. The predetermined frequency can be a frequency in a cellular band, Global Positioning System (GPS) band, Personal Communications Service (PCS) band, Long Term Evolution (LTE) band, or wireless local area network (WLAN) band. The antenna assembly can further include a second radiating element capacitively coupled to the first radiating element through a gap and the second radiating element can connect to a ground. The antenna assembly can also include a shorting pin that connects the first radiating element to a ground.

In some implementations, an antenna assembly can include a first radiating element, and a tunable circuit connecting the first radiating element to a ground. The tunable circuit can be configured to adjust a resonant frequency of the antenna assembly to a predetermined frequency. The tunable circuit can include at least a tunable capacitor and the tunable capacitor can have a substantially continuous range of capacitance. The tunable circuit can be adjusted to modify a loading impedance between the first radiating element and the ground, and modifying the loading impedance changes the resonant frequency of the antenna assembly. The predetermined frequency can be a frequency in a cellular band, GPS band, PCS band, LTE band, or WLAN band. The antenna assembly can further include a second radiating element capacitively coupled to the first radiating element through a gap and the second radiating element connected to an antenna feed. In some cases, the first radiating element can connect to an antenna feed.

In some implementations, a multiple-input multiple output (MIMO) antenna assembly can include a first antenna assembly and a second antenna assembly. The first antenna assembly includes a first radiating element including a first proximal radiating segment and a first distal radiating segment. The first antenna assembly also includes a first tunable circuit coupling the first proximal radiating segment and the first distal radiating segment and configured to adjust a resonant frequency of the first antenna assembly to a predetermined frequency. The second antenna assembly includes a second radiating element including a second proximal radiating segment and a second distal radiating segment. The second antenna assembly also includes a second tunable circuit coupling the second proximal radiating segment and the second distal radiating segment and configured to adjust a resonant frequency of the second antenna assembly to the predetermined frequency. The MIMO antenna assembly also includes a third tunable circuit connecting the first antenna assembly and the second antenna assembly and configured to modify a correlation between radiating patterns of the first antenna assembly and the second antenna assembly. At least one of the first, second or third tunable circuit includes a tunable capacitor, and the tunable capacitor has a substantially continuous range of capacitance. The third tunable circuit can be adjusted to change a coupling impedance between the first antenna assembly and the second antenna assembly, changing the coupling impedance can modify current distribution between the first antenna assembly and the second antenna assembly, and modifying the current distribution can adjust the correlation between radiating patterns of the first antenna assembly and the second antenna assembly. The predetermined frequency can be a frequency in a cellular band, GPS band, PCS band, LTE band, or WLAN band.

In some implementations, an antenna assembly resonates at a first resonant frequency. The antenna assembly can include a radiating element and a tunable circuit coupled to the radiating element. The tunable circuit can be adjusted based on a second resonant frequency. The antenna assembly can modify an electrical length of the radiating element based on the adjusted tunable circuit such that the antenna assembly resonates at the second resonant frequency. The radiating element can connect to an antenna feed and include a proximal radiating segment and a distal radiating segment. The tunable circuit can be coupled to the proximal radiating segment and the distal radiating segment and configured to adjust the electrical length of the radiating element.

In some implementations, a non-transitory computer readable medium includes instructions which, when executed, cause an antenna assembly to resonate at a first resonant frequency. The antenna assembly includes a radiating element and a tunable circuit coupled to the radiating element. The instructions can cause the tunable circuit to be adjusted based on a second resonant frequency. The instructions can also cause the antenna assembly to modify an electrical length of the radiating element based on the adjusted tunable circuit such that the antenna assembly resonates at the second resonant frequency. The radiating element can connect to an antenna feed and include a proximal radiating segment and a distal radiating segment. The tunable circuit can be coupled to the proximal radiating segment and the distal radiating segment and configured to adjust the electrical length of the radiating element.

The subject matter described herein may provide one or more advantages. The described antenna assembly can resonate at different frequencies to support operations at different frequency bands or carrier aggregation. The described antenna assembly can also provide a large operating frequency range and a high antenna efficiency to accommodate a wide range of power amplifier characteristics. The described MIMO antenna assembly can reduce a correlation between radiating patterns of the two antennas such that the MIMO system can provide a high data rate. In the context of the current invention disclosure, the terms “antenna” and “antenna assembly” are considered technically equivalent unless indicated otherwise.

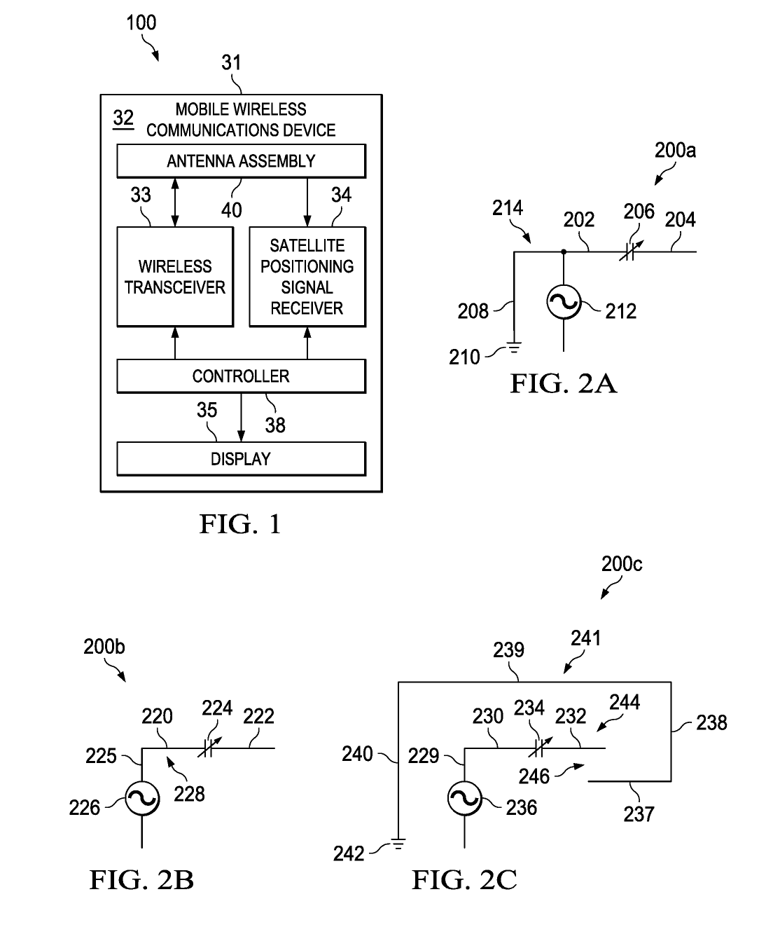

FIG. 1 shows an example mobile wireless communications device 100, according to some implementations. The mobile wireless communications device 100 illustratively includes a portable housing 31 and a printed circuit board (PCB) 32 affixed to the portable housing 31. The portable housing 31 can have an upper portion and a lower portion. As illustrated, a wireless transceiver 33 is affixed to the PCB 32. In some cases, the PCB 32 may be replaced by or used in conjunction with a metal chassis or other substrate. The PCB 32 may also include a conductive layer (not shown) defining a ground plane. A satellite positioning signal receiver 34 can also be affixed to the PCB 32. The satellite positioning signal receiver 34 may be a Global Positioning System (GPS) satellite receiver. The exemplary device 100 can also include a display 35 which may be, for example, a full graphic liquid-crystal display (LCD). The device 30 further illustratively includes an antenna assembly 40 affixed to the upper portion of the PCB 32. In some implementations, the antenna assembly 40 can include a frequency tunable antenna or MIMO antenna so that the device 100 can operate under multiple frequencies. A controller 38 or processor may also be affixed to the PCB 32. The controller 38 may be communicatively coupled to the other components, for example, the antenna assembly 40, the satellite positioning signal receiver 34, and the wireless transceiver 33 to coordinate and control operations of the mobile wireless communications device 100. In some implementations, the mobile wireless communications device 100 may include multiple PCBs, such as two PCBs connected by a connecting flex. For example, for a MIMO antenna system with two antennas, a first antenna can be on a first PCB at the upper portion of the portable housing 31 and a second antenna can be on a second PCB at the lower portion of the portable housing 31.

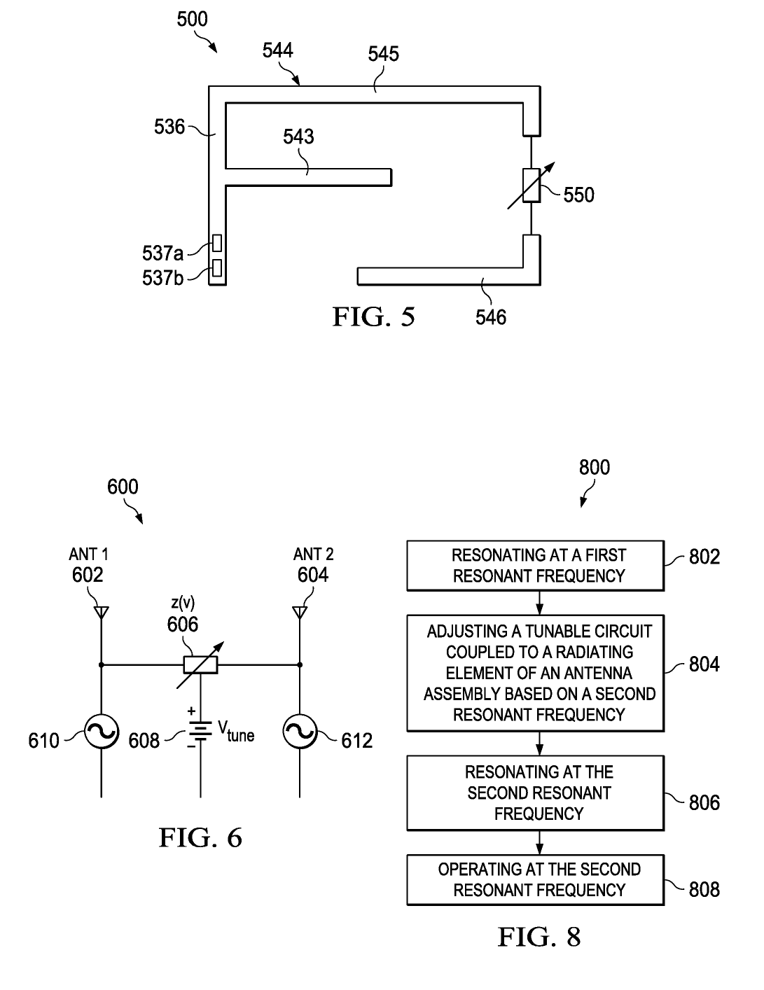

FIGS. 2A-2C illustrate frequency tunable antennas using aperture tuning. FIG. 2A illustrates aperture tuning for a planar inverted “F” antenna (PIFA) 200a, according to some implementations. The antenna 200a resembles an inverted letter “F” explaining the PIFA name but may have other configurations without departing from the scope of the disclosure. The antenna 200a has a radiating element 214 including a proximal radiating segment 202 and a distal radiating segment 204 coupled by a tunable capacitor 206. The proximal radiating segment 202 has two ends, one end connecting to the tunable capacitor 206 and the other end connecting to a shorting pin 208 that connects the radiating element 214 to a ground 210. The proximal radiating segment 202, at a point between its two ends, further connects to antenna feed 212. In some cases, the antenna feed 212 can be an AC voltage source, such as a radio frequency (RF) signal. The tunable capacitor 206 can have a continuous range of capacitance or a substantially continuous range of capacitance. In some implementation, the capacitance of the tunable capacitor can be adjusted by changing the DC voltage applied across the tunable capacitor. Adjusting the capacitance of the tunable capacitor 206 can change an electrical length of the radiating element 214. An electrical length of an antenna component can be similar to, or different from a physical length. The electrical length can be effectively adjusted by using circuit components. Adjusting the electrical length of the radiating element 214 can change the resonant frequency of the antenna 200a. In some implementations, as will be discussed in FIG. 5, PIFA 200a can be formed by a radiating patch that includes the radiating element 214.

FIG. 2B illustrates aperture tuning for an inverted “L” antenna 200b, according to some implementations. The antenna 200b resembles an inverted letter “L” explaining the name but may have other configurations without departing from the scope of the disclosure. The antenna 200b has a radiating element 228 including a proximal radiating segment 220 and a distal radiating segment 222 coupled by a tunable capacitor 224, and a third radiating segment 225. The proximal radiating segment 220 and the third radiating segment 225 form an L-shape. The third radiating segment 225 connects to antenna feed 226. The tunable capacitor 224 can have a continuous range of capacitance or a substantially continuous range of capacitance. Adjusting the capacitance of the tunable capacitor 224 can change an electrical length of the radiating element 228 and adjust the antenna resonant frequency.

FIG. 2C illustrates aperture tuning for a parasitic monopole antenna 200c, according to some implementations. The antenna 200b has a first radiating element 244 including a proximal radiating segment 230 and a distal radiating segment 232 coupled by a tunable capacitor 234, and a third radiating segment 229. The proximal radiating segment 230 and the third radiating segment 229 form an L-shape but may have other configurations without departing from the scope of the disclosure. The third radiating segment 229 connects to antenna feed 236. The antenna 200c also has a second radiating element 241 including four connected radiating segments, 237, 238, 239, 240, with segments 237, 238, 239 forming a U-shape, and segments 239 and 240 forming an L-shape. The segment 240 connects to a ground 242. The second radiating element 241 is capacitively coupled to the first radiating element 244, through a gap 246. The tunable capacitor 234 can have a continuous range of capacitance or a substantially continuous range of capacitance. Adjusting the capacitance of the tunable capacitor 234 can change an electrical length of the first radiating element 244 and adjust the antenna resonant frequency.

In some implementations, tunable capacitors 206, 224 and 234 each can be replaced by a tunable circuit which may include various tunable and non-tunable circuit components such as capacitors and/or inductors and any combination of these circuit components. As will be appreciated by those skilled in the art, capacitance values of tunable capacitors 206, 224, and 234 may be determined based on a desired or predetermined resonant frequency or frequency range, and, in some implementations, may be derived by simulation hardware and/or programs. The desired or predetermined resonant frequency or frequency range can be a frequency or frequency range in a cellular band, GPS band, PCS band, LTE band, WLAN band, or other bands.

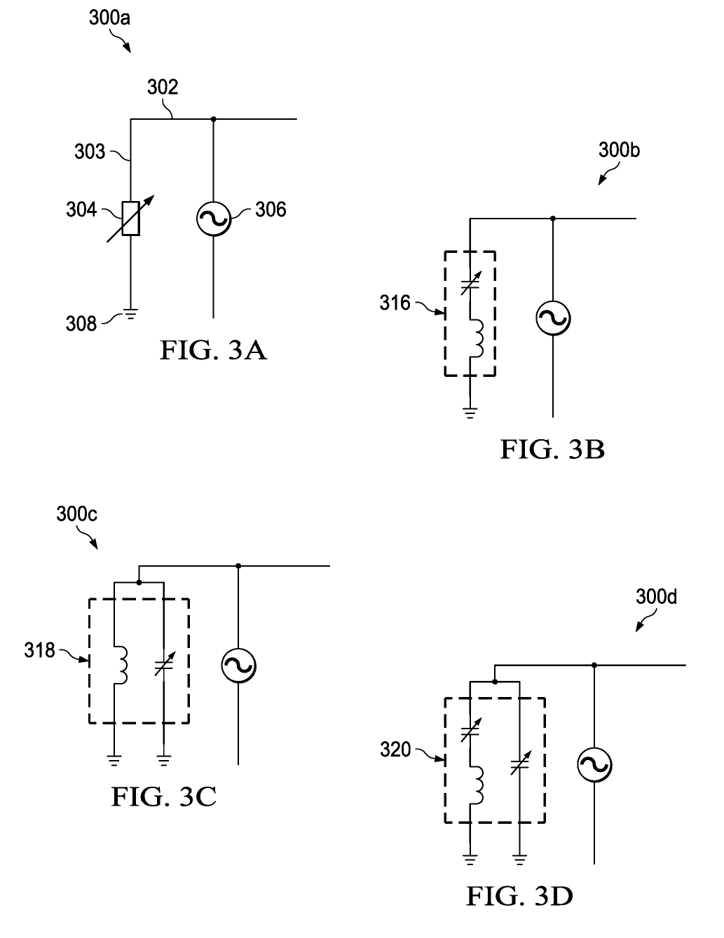

FIG. 3A illustrates a frequency tunable PIFA 300a using impedance tuning, according to some implementations. The antenna 300a includes a radiating element 302 with one end connecting to a shorting pin 303. The shorting pin 303 connects to a ground 308 through a tunable circuit 304. The radiating element 302, at a point between its two ends, connects to antenna feed 306. Adjusting the tunable circuit 304 can change a loading impedance between the shorting pin 303 and ground 308 and hence change the antenna resonant frequency. The tunable circuit 304 can include various tunable and non-tunable circuit components, such as capacitors and/or inductors and any combination of these circuit components. In some implementations, adjusting the tunable circuit 304 includes adjusting the capacitance of the tunable capacitor in the tunable circuit 304.

FIGS. 3B-3D illustrate examples of the tunable circuit in FIG. 3A. FIG. 3B illustrates a first example of impedance tuning for a PIFA 300b, according to some implementations. The antenna 300b has a tunable circuit 316 including a tunable capacitor in series with a fixed (i.e., non-tunable) inductor. FIG. 3C illustrates a second example of impedance tuning for a PIFA 300c, according to some implementations. The antenna 300c has a tunable circuit 318 including a tunable capacitor in parallel with a fixed inductor. FIG. 3D illustrates a third example of impedance tuning for a PIFA 300d, according to some implementations. The antenna 300d has a tunable circuit 320 including a first tunable capacitor in parallel with a second tunable capacitor and a fixed inductor connected in series. The tunable capacitors in tunable circuits 316, 318, and 320 can have a continuous range of capacitance or a substantially continuous range of capacitance. As will be appreciated by those skilled in the art, capacitance values of tunable capacitors in tunable circuits 316, 318, and 320 may be determined based on a desired or predetermined resonant frequency or frequency range, and, in some implementations, may be derived by simulation hardware and/or programs. The desired or predetermined resonant frequency or frequency range can be a frequency or frequency range in a cellular band, GPS band, PCS band, LTE band, WLAN band, or other bands.

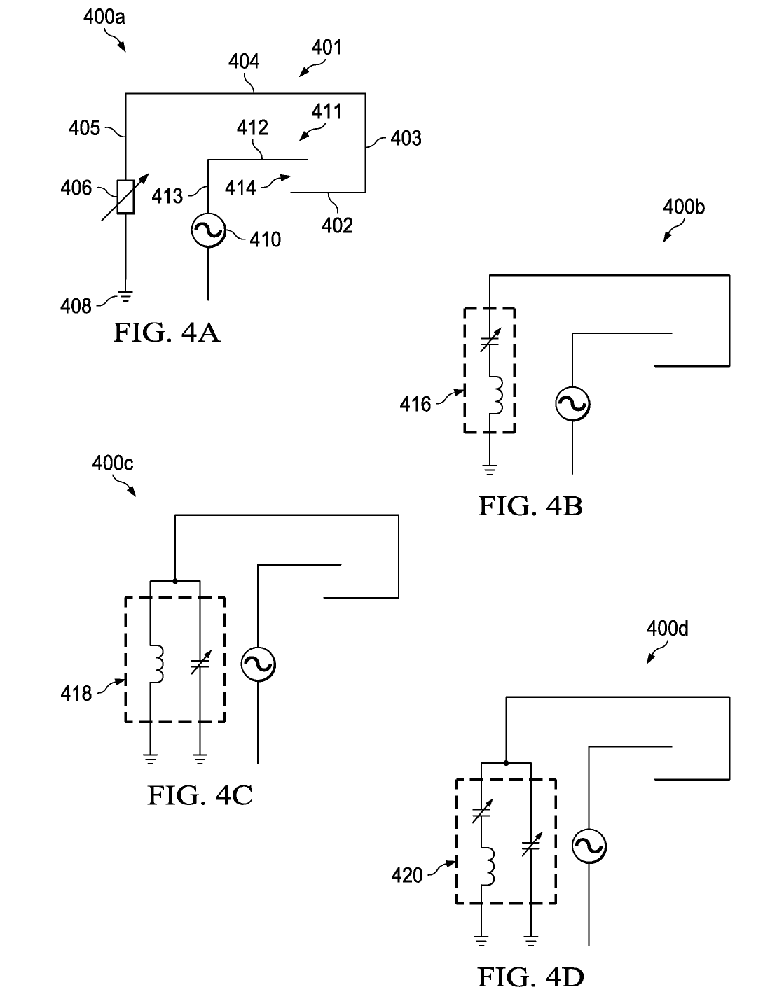

FIG. 4A illustrates using impedance tuning to enable frequency tuning for a parasitic monopole antenna 400a, according to some implementations. The antenna 400a has a first radiating element 401 including four connected segments 402, 403, 404, and 405. The segment 405 connects to a ground 408 through a tunable circuit 406. The antenna 400a also has a second radiating element 411 including two segments 412 and 413. The segment 413 connects to antenna feed 410. The first radiating element 401 is capacitively coupled to the second radiating element 411 through a gap 414. Adjusting the tunable circuit 406 can change a loading impedance between the first radiating element 401 and ground 408, and hence change the antenna resonant frequency. The tunable circuit 406 can include various tunable and non-tunable circuit components, such as capacitors and/or inductors and any combination of these circuit components. In some implementations, adjusting the tunable circuit 406 includes adjusting the capacitance of the tunable capacitor in the tunable circuit 406.

In some implementations, a respective size and shape of each of the first radiating element 401 and the second radiating element 411, and the gap 414 for capacitive coupling are chosen such that the first radiating element 401 and the second radiating element 411 resonate in certain frequency ranges such as about 700 to about 960 MHz, about 1710 MHz to about 2170 MHz, or about 2500 MHz to about 2700 MHz. For example, in the first radiating element 401, segment 405 can have a length between about 5 mm to about 17 mm, segment 404 can have a length between about 20 mm to about 60 mm, segment 403 can have a length between about 5 mm to about 10 mm, and segment 402 can have a length between about 5 mm to about 20 mm. In the second radiating element 411, segment 413 can have a length between about 5 mm to about 12 mm, and segment 412 can have a length between about 10 mm to about 30 mm. A width of each segment 402, 403, 404, 405, 412, and 413 can be between about 2 mm and about 15 mm. The gap 414 can range from about 0.5 mm to about 2 mm.

FIGS. 4B-4D illustrate examples of the tunable circuit in FIG. 4A. FIG. 4B illustrates a first example of impedance tuning for a parasitic monopole antenna 400b, according to some implementations. The antenna 400b has a tunable circuit 416 including a tunable capacitor in series with a fixed inductor. FIG. 4C illustrates a second example of impedance tuning for a parasitic monopole antenna 400c, according to some implementations. The antenna 400c has a tunable circuit 418 including a tunable capacitor in parallel with a fixed inductor. FIG. 4D illustrates a third example of impedance tuning for a parasitic monopole antenna 400d, according to some implementations. The antenna 400d has a tunable circuit 420 including a first tunable capacitor in parallel with a second tunable capacitor and a fixed inductor connected in series. The tunable capacitors in tunable circuits 416, 418, and 420 can have a continuous range of capacitance or a substantially continuous range of capacitance. As will be appreciated by those skilled in the art, capacitance values of tunable capacitors in tunable circuits 416, 418 and, 420 may be determined based on a desired or predetermined resonant frequency or frequency range, and, in some implementations, may be derived by simulation hardware and/or programs. The desired or predetermined resonant frequency or frequency range can be a frequency or frequency range in a cellular band, GPS band, PCS band, LTE band, WLAN band, or other bands.

FIG. 5 illustrates an example radiating patch 500 of a PIFA, according to some implementations. The radiating element 214 in FIG. 2A or the radiating element 302 in FIG. 3A can be realized by the radiating patch 500. The PIFA radiating patch 500 includes two arms that may be tuned to different frequency bands. The patch 500 illustratively includes a base conductor 536 having a pair of antenna feed points 537a, 537b. In some implementations, the feed point 537a may connect to a RF signal, and the feed point 537b may connect to a ground.

The patch 500 also includes a first conductor arm 543 extending outwardly from the base conductor 536. The first conductor arm 543 can create, for example, a resonant frequency between 1930 MHz and 1990 MHz, which is in the PCS band. The first conductor arm 543 can also be resonant at other frequency ranges.

The patch 500 also includes a second conductor arm 544 also extending outwardly from the base conductor 536. The second conductor arm 544 illustratively includes a proximal conductor portion 545 adjacent the base conductor 536. The proximal conductor portion 545 is illustratively L-shaped. The proximal conductor portion 545 may be other shapes, as will be appreciated by those skilled in the art.

The second conductor arm 544 also illustratively includes a distal conductor portion 546. The distal conductor portion is also L-shaped. The distal conductor portion 546 may be other shapes, as will be appreciated by those skilled in the art.

The second conductor arm 544 can create a resonant frequency, for example, between 869 MHz and 894 MHz, which is in the cellular band. The second conductor arm 544 may also be tuned to resonate at other frequency ranges.

The second conductor arm 544 also includes a tunable circuit 550 coupling the proximal and distal conductor portions 545, 546. In other words, the proximal and distal conductor portions 545, 546 are spatially separated, or have a gap there between. The tunable circuit 550 bridges the gap between or couples the proximal and distal conductor portions 545, 546 so that the second conductor arm 544 has an overall J-shape. The first conductor arm 543 extends within the J-shape of the second conductor arm 544. The second conductor arm 544 may be another shape, as defined by the proximal and distal conductor portions 545, 546.

The tunable circuit 550 may include various tunable and non-tunable circuit components, such as capacitors and/or inductors and any combination of these circuit components. The tunable circuit 550 can cooperate with the proximal and distal conductor portions 545, 546 to create a resonant frequency. As will be appreciated by those skilled in the art, the desired component values of the tunable circuit 550 may be based upon a desired frequency or frequency range and may be derived by simulation hardware and/or programs.

FIG. 6 illustrates a MIMO antenna assembly 600, according to some implementations. The MIMO antenna assembly 600 includes two antennas 602 and 604 which are connected to antenna feeds 610 and 612, respectively. In some implementations, antenna 602 and antenna feed 610 can be implemented by a tunable antenna assembly shown in FIG. 2A-2C, 3A-3D, or 4A-4D. Similarly, antenna 604 and antenna feed 612 can be implemented by a tunable antenna assembly in FIG. 2A-2C, 3A-3D, or 4A-4D, which may be a same or different antenna assembly for antenna 602 and antenna feed 610. In other words, each of the antennas 602 and 604 can be a tunable antenna assembly in FIG. 2A-2C, 3A-3D, or 4A-4D without the antenna feed. In some implementations, antenna feeds 610 and 612 can be a same antenna feed or different antenna feeds. The antenna assembly of antenna 602 and antenna feed 610 can be tuned to resonate at a first predetermined frequency. The antenna assembly of antenna 604 and antenna feed 612 can be tuned to resonate at a second predetermined frequency. The first and second predetermined frequency can be a same frequency or different frequencies. The predetermined frequency can be a frequency in a cellular band, GPS band, PCS band, LTE band, WLAN band, or other bands.

The antenna assembly of antenna 602 and antenna feed 610 and the antenna assembly of antenna 604 and antenna feed 612 are coupled by a tunable circuit 606 connecting to a DC voltage source 608. In some implementations, the tunable circuit 606 can include various tunable and non-tunable circuit components, such as capacitors and/or inductors and any combination of these circuit components. For example, the tunable circuit 606 can be a tunable capacitor and its capacitance can be tuned by adjusting the DC voltage 608. The tunable capacitor can have a continuous range of capacitance or a substantially continuous range of capacitance.

To improve performance of a MIMO antenna system, it is desirable to reduce a correlation between radiation patterns of the two antennas 602 and 604. By adjusting an impedance of the tunable circuit 606, current flows to antennas 602 and 604 can change. A current may flow from antenna feed 610 to antenna 604 though the tunable circuit 606, and the amount of the current may depend on the impedance of the tunable circuit 606. For example, more current may flow from antenna feed 610 to antenna 604 if the tunable circuit has a small impedance. Adjusting the impedance of the tunable circuit 606 can change the way how the current from antenna feed 610 is distributed between antennas 602 and 604. In some implementations, the impedance of the tunable circuit 606 can be adjusted by changing the capacitance of the tunable capacitor in the tunable circuit 606. Therefore, the current flow to antenna 604 is a combination of currents from antenna feeds 610 and 612. Similarly, the current flow to antenna 602 is a combination of currents from antenna feeds 610 and 612. Adjusting the impedance of the tunable circuit 606 can also change the way how the current from antenna feed 612 is distributed between antennas 602 and 604. Changing the current distribution between antennas 602 and 604 can cause radiation patterns of antennas 602 and 604 to vary and hence change the correlation between radiation patterns of antennas 602 and 604. In other words, adjusting the coupling impedance between antennas 602 and 604 may reduce the correlation between radiating patterns of antennas 602 and 604 and hence improve performance of a MIMO system, such as increasing a MIMO channel capacity or increasing data rates of a MIMO system.

In some implementation, the tunable circuit 606 can be adjusted such that the radiation patterns of antennas 602 and 604 are orthogonal to each other leading to a low correlation, for example, zero correlation, and optimize performance of the MIMO system. In some implementations, the MIMO antenna assembly 600 can support carrier aggregation such that the mobile communications device can aggregate multiple frequency carriers to increase data rates. For example, an LTE device may aggregate frequency carriers within the same LTE band or from different LTE bands.

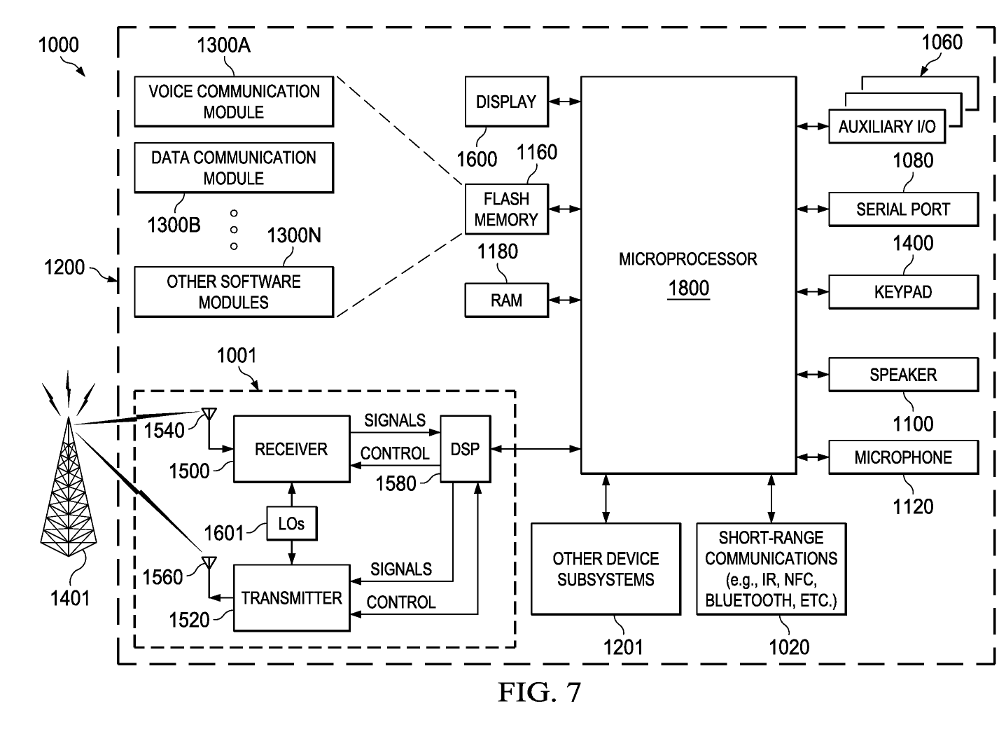

FIG. 7 illustrates example components of a mobile wireless communications device 1000 that may be used in accordance with the described antenna assemblies. A mobile wireless communications device 1000 illustratively includes a housing 1200, a keyboard or keypad 1400 and an output device 1600. The output device shown is a display 1600, which may be a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 7. These include a communications subsystem 1001; a short-range communications subsystem 1020; the keypad 1400 and the display 1600, along with other input/output devices 1060, 1080, 1100, and 1120; as well as memory devices 1160, 1180, and various other device subsystems 1201. The mobile device 1000 may include a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized, and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, time division multiple access (TDMA), code division multiple access (CDMA), wideband CDMA (WCDMA), PCS, GSM, enhanced data rates for GSM evolution (EDGE), etc. Other types of data and voice networks, both separate and integrated, may also be utilized with the mobile device 1000. The mobile device 1000 may also be compliant with other communications standards such as GSM, UMTS, LTE, LTE-Advanced, etc.

Network access requirements vary depending upon the type of communication system. For example, in the Mobitex and DataTAC networks, mobile devices are registered on the network using a unique personal identification number, or PIN, associated with each device. In GPRS networks, however, network access is associated with a subscriber, or user of a device. A GPRS device therefore typically involves use of a subscriber identity module, commonly referred to as a subscriber identification module (SIM) card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively, to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401, via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) sensor for communicating with a NFC device or NFC tag via NFC communications.

FIG. 8 is a flowchart illustrating an example method 800 for aperture tuning, according to some implementations. For clarity of presentation, the description that follows generally describes method 800 in the context of the other figures in this description. In some implementations, various steps of method 800 can be run in parallel, in combination, in loops, or in any order.

At 802, an antenna assembly can resonate at a first resonant frequency. In some implementations, the first frequency can be a frequency in a cellular band, GPS band, PCS band, LTE band, or WLAN band. The antenna assembly can be an antenna assembly described in FIGS. 2A-2C, 3A-3D, 4A-4D, 5, and 6. The antenna assembly can include a radiating element and a tunable circuit coupled to the radiating element. The tunable circuit can include a tunable capacitor that has a continuous range of capacitance or a substantially continuous range of capacitance. From 802, method 800 proceeds to 804.

At 804, the antenna assembly can adjust the tunable circuit based on a second resonant frequency. In some implementations, the second frequency can be a frequency in a cellular band, GPS band, PCS band, LTE band, or WLAN band that is different from the first frequency. For example, a mobile device may operate at a first LTE frequency in its home country. When the device roams to a different country, the device may need to operate on a different LTE frequency because different countries use different LTE frequency bands. The antenna assembly can adjust capacitance of the tunable capacitor in the tunable circuit such that the antenna assembly can resonate at the second frequency. In some implementations, the controller 38, the wireless transceiver 33, or the satellite positioning signal receiver 34 in FIG. 1 may determine the capacitance value of the tunable capacitor based on the second resonant frequency, and indicate the determined capacitance value to the tunable circuit so that the tunable capacitor can be tuned to the desired capacitance value. In some cases, the controller 38, the wireless transceiver 33, or the satellite positioning signal receiver 34 may send a control signal to the tunable circuit, for example, to control the DC voltage across the tunable capacitor. In some implementations, as shown in FIGS. 3A-3D and 4A-4D, the tunable circuit connects the radiating element to a ground. Adjusting the tunable circuit can change a loading impedance between the radiating element and the ground, and further adjust the resonant frequency. From 804, method 800 proceeds to 806.

At 806, the antenna assembly can modify an electrical length of the radiating element based on the adjusted tunable circuit. In some implementations, as shown in FIGS. 2A-2C, the radiating element in the antenna assembly connects to an antenna feed and includes a proximal radiating segment and a distal radiating segment. The tunable circuit is coupled to the proximal radiating segment and the distal radiating segment. Adjusting the tunable circuit can change the electrical length of the radiating element, and further adjust the resonant frequency. From 806, method 800 proceeds to 808.

At 808, the antenna assembly resonates at the second frequency. From 808, method 800 stops.

The example method of FIG. 8 may be implemented using coded instructions (e.g., computer readable instructions) stored on a tangible computer readable medium such as a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example method of FIG. 8 may be implemented using coded instructions (e.g., computer readable instructions) stored on a non-transitory computer readable medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Also, in the context of the current invention disclosure, as used herein, the terms “computer readable” and “machine readable” are considered technically equivalent unless indicated otherwise.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation descried above should not be understood as requiring such separation in all implementations, and it should be understood that the described program components and systems can generally be integrated together in a signal software product or packaged into multiple software products.

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art, and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps are not implied by the order they appear in the claims.

1-20. (canceled)

21. An antenna assembly, comprising:
a first antenna comprising:
a first radiating element including a first proximal radiating segment and a first distal radiating segment; and
a first tunable circuit connecting the first proximal radiating segment and the first distal radiating segment and configured to adjust a resonant frequency of the first antenna to a first frequency;
a second antenna comprising:
a second radiating element including a second proximal radiating segment and a second distal radiating segment; and
a second tunable circuit connecting the second proximal radiating segment and the second distal radiating segment and configured to adjust a resonant frequency of the second antenna to a second frequency; and
a third tunable circuit coupling the first antenna and the second antenna.

22. The antenna assembly of claim 21, wherein at least one of the first, second, or third tunable circuit comprises a tunable capacitor, and the tunable capacitor has a continuous range of capacitance.

23. The antenna assembly of claim 21, wherein the third tunable circuit is adjusted to change a coupling impedance between the first antenna and the second antenna, changing the coupling impedance modifies a current distribution between the first antenna and the second antenna, and modifying the current distribution adjusts a correlation between radiating patterns of the first antenna and the second antenna.

24. The antenna assembly of claim 21, wherein the third tunable circuit is connected to a direct current (DC) voltage source.

25. The antenna assembly of claim 21, wherein the first antenna is connected to a ground.

26. The antenna assembly of claim 21, wherein the first antenna is connected to a first antenna feed, the second antenna is connected to a second antenna feed, and the first antenna feed is different from the second antenna feed.

27. The antenna assembly of claim 21, wherein the first antenna and the second antenna are connected to a same antenna feed.

28. The antenna assembly of claim 21, wherein the first frequency is a frequency in a cellular band, Global Positioning System (GPS) band, Personal Communications Service (PCS) band, Long Term Evolution (LTE) band, or wireless local area network (WLAN) band.

29. The antenna assembly of claim 21, wherein the first frequency is the same as the second frequency.

30. The antenna assembly of claim 21, wherein the first frequency is different from the second frequency.

31. A method performed at an antenna assembly including a first antenna, a second antenna, and a tunable circuit coupling the first antenna and the second antenna, comprising:
resonating, by the first antenna, at a first resonant frequency, wherein the first antenna comprises:
a first radiating element including a first proximal radiating segment and a first distal radiating segment; and
a first tunable circuit connecting the first proximal radiating segment and the first distal radiating segment and configured to adjust the first resonant frequency to a third resonant frequency;
resonating, by the second antenna, at a second resonant frequency, wherein the second antenna comprises:
a second radiating element including a second proximal radiating segment and a second distal radiating segment; and
a second tunable circuit connecting the second proximal radiating segment and the second distal radiating segment and configured to adjust the second resonant frequency to a fourth resonant frequency;
resonating, by the first antenna, at the third resonant frequency by adjusting the first tunable circuit;
resonating, by the second antenna, at the fourth resonant frequency by adjusting the second tunable circuit; and
adjusting the tunable circuit coupling the first antenna and the second antenna.

32. The method of claim 31, wherein at least one of the first tunable circuit, the second tunable circuit, or the tunable circuit coupling the first antenna and the second antenna comprises a tunable capacitor, and the tunable capacitor has a continuous range of capacitance.

33. The method of claim 31, wherein the tunable circuit coupling the first antenna and the second antenna is adjusted to change a coupling impedance between the first antenna and the second antenna, changing the coupling impedance modifies a current distribution between the first antenna and the second antenna, and modifying the current distribution adjusts a correlation between radiating patterns of the first antenna and the second antenna.

34. The method of claim 31, wherein the third resonant frequency is the same as the fourth resonant frequency.

35. The method of claim 31, wherein the third resonant frequency is different from the fourth resonant frequency.

36. The method of claim 31, wherein the third resonant frequency is a frequency in a cellular band, Global Positioning System (GPS) band, Personal Communications Service (PCS) band, Long Term Evolution (LTE) band, or wireless local area network (WLAN) band.

37. A non-transitory computer readable medium comprising instructions which, when executed, cause an antenna assembly including a first antenna, a second antenna, and a tunable circuit coupling the first antenna and the second antenna to perform operations comprising:
resonating, by the first antenna, at a first resonant frequency, wherein the first antenna comprises:
a first radiating element including a first proximal radiating segment and a first distal radiating segment; and
a first tunable circuit connecting the first proximal radiating segment and the first distal radiating segment and configured to adjust the first resonant frequency to a third resonant frequency;
resonating, by the second antenna, at a second resonant frequency, wherein the second antenna comprises:
a second radiating element including a second proximal radiating segment and a second distal radiating segment; and
a second tunable circuit connecting the second proximal radiating segment and the second distal radiating segment and configured to adjust the second resonant frequency to a fourth resonant frequency;
resonating, by the first antenna, at the third resonant frequency by adjusting the first tunable circuit;
resonating, by the second antenna, at the fourth resonant frequency by adjusting the second tunable circuit; and
adjusting the tunable circuit coupling the first antenna and the second antenna.

38. The non-transitory computer readable medium of claim 37, wherein at least one of the first tunable circuit, the second tunable circuit, or the tunable circuit coupling the first antenna and the second antenna comprises a tunable capacitor, and the tunable capacitor has a continuous range of capacitance.

39. The non-transitory computer readable medium of claim 37, wherein the tunable circuit coupling the first antenna and the second antenna is adjusted to change a coupling impedance between the first antenna and the second antenna, changing the coupling impedance modifies a current distribution between the first antenna and the second antenna, and modifying the current distribution adjusts a correlation between radiating patterns of the first antenna and the second antenna.

40. The non-transitory computer readable medium of claim 37, wherein the third resonant frequency is a frequency in a cellular band, Global Positioning System (GPS) band, Personal Communications Service (PCS) band, Long Term Evolution (LTE) band, or wireless local area network (WLAN) band.
